(19) United States
(12) Patent Application Publication
(10) Pub. No.: US 2006/0216684 A1
(43) Pub. Date: Sep. 28, 2006

(54) Study reference book allowing easy confirmation of correct answers

(76) Inventor: Won Jeon, Seoul (KR)

Correspondence Address: LERNER GREENBERG STEMER LLP, P O BOX 2480, HOLLYWOOD, FL, 33022-2480, US

(21) Appl. No.: 11/374,514

(22) Filed: Mar. 13, 2006

(30) Foreign Application Priority Data
Mar. 14, 2005 (KR) 20 2005 0006716

(51) Int. Cl. G09B 3/00

(52) U.S. Cl. 434/322

(57) ABSTRACT

Disclosed herein is a study reference book. The study reference book comprises question pages, explanation pages, and a securing member to secure the question pages and the explanation pages. Each question page comprises question items, multiple choice answers related to each question item, an answer-marking part on which a correct answer of each question item is marked, and a first correct answer-punctured space for a previous question page. Each explanation page is positioned at an opposing side of the question page when the study reference book is open, and comprises explanation items for the question items, and a second correct answer-punctured space positioned to locate correctly at a correct answer-indicating space of the answer-marking part of the question page when leafing the explanation page leftward to overlap the question page. A user can confirm whether or not answers marked on the answer-marking part are correct immediately after marking the answers.

### BACKGROUND OF THE INVENTION

1. Field of the Invention

The present invention relates to a study reference book allowing easy confirmation of correct answers. More particularly, the present invention relates to a study reference book, which allows use of an explanation page, and easy confirmation of correct answers immediately after solving problems in the study reference book.

2. Description of the Related Art

Generally, various types of study reference book are used by students, and persons preparing for examinations for employment, certification, promotion, and the like. The study reference book comprises question solving sections, explanation sections, correct answer sections, and the like.

The study reference book comprises a number of questions to test whether or not a user understands contents of study material or to enhance capability of solving the questions related to the study material. Generally, when opening the reference book, several questions are set forth on a left or right page, and correct answers and explanations thereof are set forth on a lower part of the page or on the other pages. Alternatively, the correct answers and explanations are provided in a rear section of the study reference book as an appendix. However, in the case where the appendix of the correct answers and explanations is included in the rear section of the study reference book, there is a problem in that, since the user generally separates the appendix to use the appendix, the study reference book is damaged. In addition, even though the study reference book is used without tearing the appendix, there are problems of inconvenience, waste of time, and lower studying efficiency related to confirmation of the correct answers.

Additionally, in order to solve the problems as mentioned above, a study reference book disclosed in Korean Patent No. 10-0269950 comprises a main book 111 having a space 113 to receive a separate volume 112 as an independent volume which presents correct answers and explanations of questions therein, as shown in FIG. 8. However, when the separate volume 112 provided as the independent volume is lost, the main book 111 presenting the problems is likely to become useless. Furthermore, there is a problem in that, since it is necessary to open the separate volume 112 together with the main book 111 when searching for the correct answers corresponding to the questions in the main book 111, it is inconvenient to use.

In order to solve the problem of the prior art, a study reference book is known in the art, in which several questions are set forth on a left or right page, and correct answers and explanations thereof are set forth on the other page of the open study reference book, as shown in FIG. 9. However, since the correct answers and explanations are set forth near the questions, there is a problem in that, when solving the questions, the user recognizes the correct answers unconsciously, which lowers studying efficiency.

### SUMMARY OF THE INVENTION

The present invention has been made to solve the above problems, and it is an object of the present invention to provide a study reference book, which allows a user to confirm whether or not an answer marked on a answer-marking part is a correct answer, immediately after solving questions in the study reference book, and marking answers of the questions.

It is another object of the present invention to provide the study reference book, which allows the user to confirm correct answers of questions without tearing out an answering appendix for confirmation of the correct answers after solving the questions.

It is yet another object of the present invention to provide the study reference book, which can reduce a time and an effort for confirmation of the correct answers after solving the questions therein, thereby improving studying efficiency.

According to one aspect of the present invention, the above and other objects can be accomplished by the provision of a study reference book, comprising: question pages, each comprising question items to evaluate learning content, multiple choice answers related to each question item, an answer-marking part on which a correct answer of each question item is marked, and correct answer-punctured spaces for a previous question page to indicate a correct answer related to each question item in the previous question page on the answer-marking part of the previous question page; explanation pages, each being positioned at an opposing side of an associated question page when the study reference book is open, and comprising explanation items to enhance understanding of the question items, and a correct answer-punctured space positioned to locate correctly at a correct answer-indicating space of the answer-marking part in an associated question item of the question page when leafing the explanation page leftward to overlap the question page; and a securing member to secure the pages such that the question page, and the explanation page are sequentially opened when leafing the pages.

### BRIEF DESCRIPTION OF THE DRAWINGS

The foregoing and other objects and features of the present invention will be more clearly understood from the following detailed description taken in conjunction with the accompanying drawings, in which:

FIG. 1a is a view illustrating a study reference book allowing easy confirmation of correct answers according to the present invention;

FIGS. 1b, 1c, 1d and 1e are views illustrating modifications of the study reference book according to the invention, in which marking spaces of an answer-marking part 4 have a circular shape, a triangular shape, a pentagonal shape, and a star shape, respectively, instead of a rectangular shape of FIG. 1a;

FIGS. 2a and 2b are views illustrating an embodiment of the study reference book according to the present invention;

FIGS. 2c and 2d are views illustrating another embodiment of the study reference book according to the present invention, in which positions of question page and the explanation page are different from those of the study reference book shown in FIGS. 2a and 2b;

FIGS. 3a and 3b are views illustrating yet another embodiment of the study reference book according to the present invention;

FIGS. 4a and 4b are views illustrating yet another embodiment of the study reference book according to the present invention;

FIGS. 5a and 5b are views illustrating yet another embodiment of the study reference book according to the present invention, in which pages of the study reference book are leafed up and down around a spring securing member;

FIGS. 6a and 6b are views illustrating yet another embodiment of the study reference book according to the present invention; and

FIGS. 7a and 7b are views illustrating yet another embodiment of the study reference book according to the present invention.

### DESCRIPTION OF THE PREFERRED EMBODIMENTS

Preferred embodiments of the present invention will be described in detail with reference to the accompanying drawings.

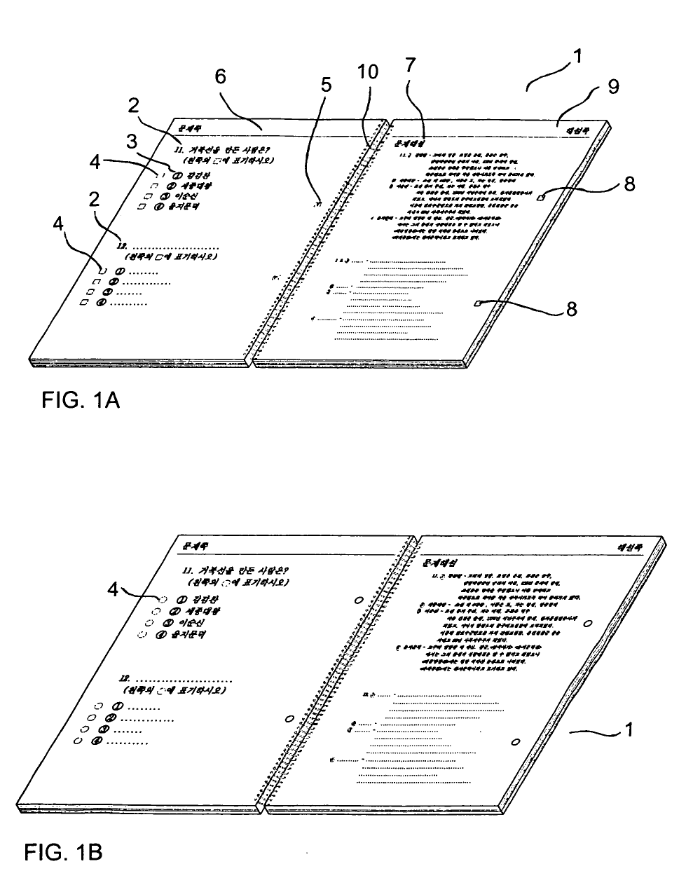

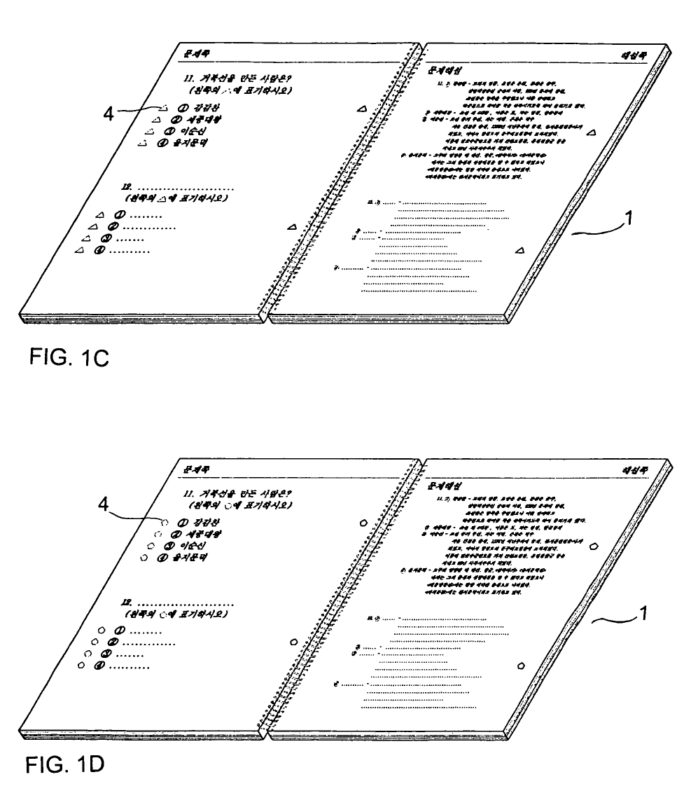

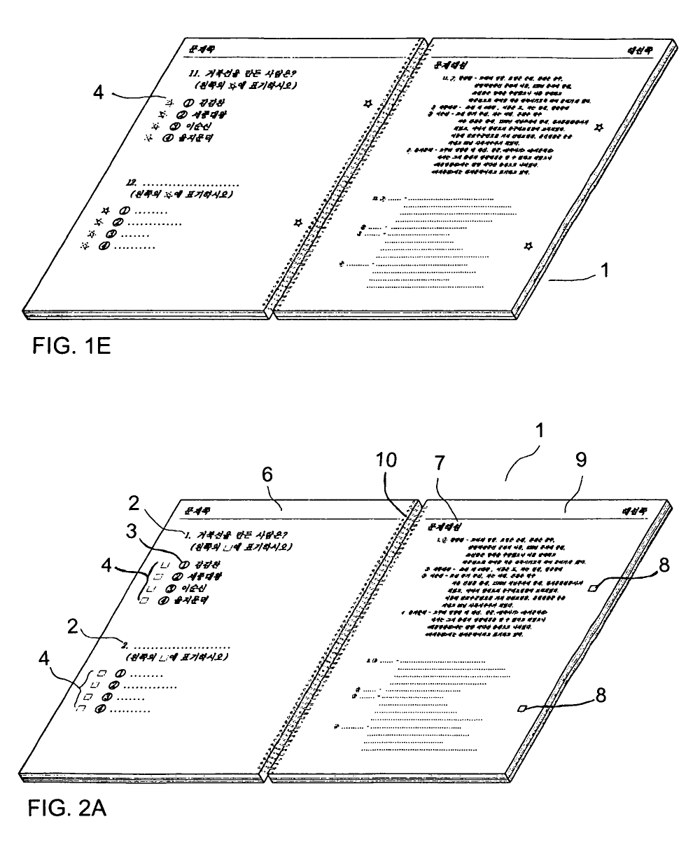

FIG. 1a is a view illustrating a study reference book allowing easy confirmation of correct answers according to the present invention.

As shown in FIG. 1a, a study reference book 1 comprises question pages 6, each of which comprises a plurality of question items 2 to evaluate learning content, multiple choice answers 3 related to each question item, an answer-marking part 4 to allow a correct answer of an associated question item to be marked therein, and a correct answer-punctured space 5 for a previous question page to indicate the correct answer related to the question item in the previous question page on the answer-marking part of the previous question page. As such, each of the question pages 6 has the plural question items 2 set forth thereon to evaluate and test the learning contents. In addition, each question page 6 has the multiple choice answers 3 related to each question item 2. Although the multiple choice answers 3 are illustrated as four choice answers 3 in this embodiment, the number of multiple choice answers is not limited to four. In each of the question items 2, the answer-marking part 4 comprises multiple marking spaces corresponding to the multiple choice answers 3, on which a correct answer of the question item 2 is marked with reference to the multiple choice answers 3. In other words, after solving the question items on the question page 6, a user marks correct answers of the question items on the answer-marking parts 4 related to the question items 2. In addition, on each of the question pages 6, the correct answer-punctured space 5 for the previous question page is punctured at a right side with respect to the answer-marking part 4 such that a correct answer of an associated question item is marked on the answer-marking part of the previous question page. The correct answer-punctured space 5 is located correctly at a correct answer indicating space of the answer-marking part (the other side of the current question page) of the previous question page, which indicates the correct answer of the question item set forth on the previous question page.

Referring to FIG. 1a again, the study reference book 1 comprises explanation pages 9, each of which is positioned at a right side on the open study reference book 1. On the explanation page 9, explanation items 7 are set forth to enhance understanding of the question items 2 of the question page 6. Each of the explanation items 7 is set forth in enough detail for the user to solve or comprehend the question item on the left page, and comprises additional comments or explaining examples described in detail. Each of the explanation pages 9 comprises a correct answer-punctured space 8 positioned to locate correctly at a correct answer-indicating space of the answer-marking part 4 of an associated question item 2 when leafing the explanation page 9 leftward to overlap the question page 6 positioned at the left page. With this structure, when studying with the study reference book 1 of the invention, the user does not suffer from troublesome effort of searching an appendix for correct answers to confirm correct answers or separately finding the correct answers corresponding to respective questions through a complicated process while solving the questions in the study reference book. Instead, the user can confirm the correct answers with convenience simply by turning the explanation page next to the question page. As a result, it is possible to reduce a time for confirming the correct answers of the question items while preventing inefficiency of finding the correct answers, thereby enhancing studying efficiency.

The study reference book 1 further comprises a securing member 10 to secure the pages 6 and 9 such that the question pages 6 and the explanation pages 9 can be continuously opened when leafing the pages. Although the member 10 is illustrated as a spring in FIG. 1a, it should be noted that the engagement member is not limited to the spring, and that the member 10 may comprise various means such as a bonding agent for books, a binder for books, and the like.

FIGS. 1b, 1c, 1d and 1e show modifications of the reference book 1 shown in FIG. 1, in which each marking space of the answer-marking part 4 has a circular shape, a triangular shape, a pentagonal shape, and a star shape, respectively, instead of rectangular-shaped marking spaces of the answer-marking part 4 shown in FIG. 1.

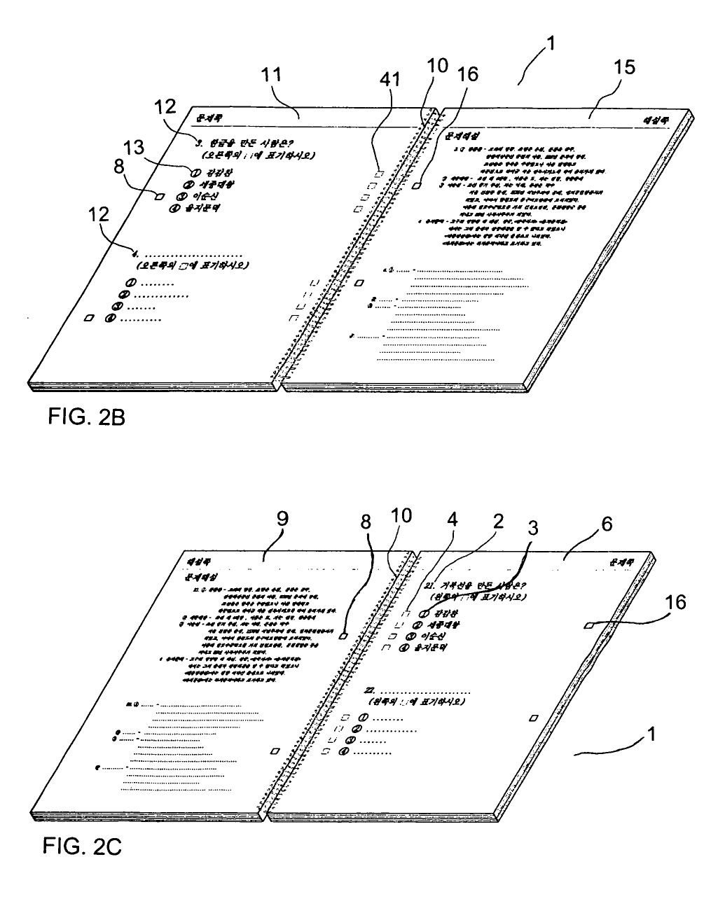

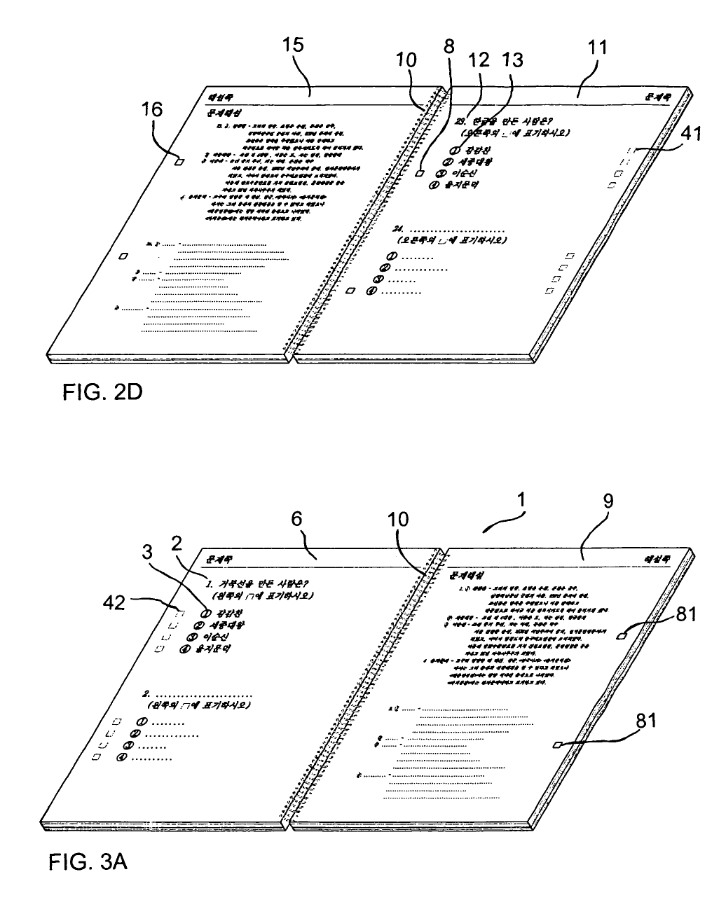

FIGS. 2a and 2b are views illustrating an embodiment of the study reference book according to the present invention.

In the embodiment shown in FIG. 2a, a question page 6 to evaluate learning content is positioned at a left page of the open study reference book, and comprises a left side answer-marking part 4 positioned at a left side of the multiple choice answers 3 of each question item 2. In addition, an explanation page 9 to help a user solve the question items is positioned at a right page, and comprises a right end correct answer-punctured space 8 positioned to overlap an associated left side answer-marking part 4 of the question page 6 when leafing the explanation page 9 leftward to overlap the question page 6, thereby indicating the correct answer of each question item 2.

FIG. 2b shows the study reference book 1 when the explanation page 9 of FIG. 2a is leafed leftward. In the study reference book 1 shown in FIG. 2b, a rear-side question page 11 to continuously evaluate the learning content is positioned at the left page when opening the study reference book 1 by leafing the explanation page 9 having the right end correct answer-punctured space 8 leftward to overlap the question page 6. The rear-side question page 11 comprises question items 12, multiple choice answers 13 of each question item 2, and a right side answer-marking part 41 positioned at a right side of the multiple choice answers 13. In addition, a rear-side explanation page 15 to help the user solve the question items is positioned at the right page thereon. The rear-side explanation page 15 comprises a left end correct answer-punctured space 16 positioned to overlap an associated right side answer-marking part 41 of the rear-side question page 11 when leafing the explanation page 15 leftward to overlap the rear-side question page 11, thereby indicating the correct answer of each question item. That is, the study reference book 1 of the invention comprises the question pages 6, the explanation pages 9, the rear-side question pages 11, the rear-side explanation pages 15, and a securing member 10 to secure the pages 6, 9, 11 and 15 into a book such that the question page 6, the explanation page 9, the rear-side question page 11, and the rear-side explanation page 15 are sequentially opened when leafing the pages. Although the securing member 10 is illustrated as a spring in FIGS. 2a and 2b, it should be noted that the present invention is not limited to the spring, and that the securing member 10 may comprise various means such as a bonding agent for books, a binder for books, and the like.

FIGS. 2c and 2d are views illustrating another embodiment of the study reference book according to the invention, in which positions of the question page and the explanation page are different from those of the study reference book shown in FIGS. 2a and 2b.

In the embodiment shown in FIG. 2c, a question page 6′ to evaluate learning content is positioned at a right page of the open study reference book 1, and comprises a left side answer-marking part 4′ positioned at a left side of the multiple choice answers 3 of each question item 2. In addition, an explanation page 9′ to help the user solve the question items is positioned at a left page of the open study reference book 1, and comprises a right end correct answer-punctured space 8′ positioned to overlap an associated left side answer-marking part 4′ on the question page 6′ when leafing the explanation page 9′ to overlap the question page 6′, thereby indicating the correct answer of each question item 2.

FIG. 2d shows the study reference book 1 of this embodiment when the explanation page 9′ of FIG. 2c is leafed rightward. In the study reference book 1 shown in FIG. 2d, a rear-side question page 11′ to continuously evaluate the learning content is positioned at the right page of the study reference book 1 opened by leafing the explanation page 9 having the right end correct answer-punctured space 8′ rightward to overlap the question page 6′. The rear-side question page 11′ comprises question items 12, multiple choice answers 13 of each question item 2, and a right side answer-marking part 41′ positioned at a right side of the multiple choice answers 13. In addition, a rear-side explanation page 15′ to help the user solve the question items is positioned at the left page of the open study reference book 1. The rear-side explanation page 15′ comprises a left end correct answer-punctured space 16′ positioned to overlap an associated right side answer-marking part 41′ on the rear-side question page 11′ when leafing the explanation page 15′ rightward to overlap the rear-side question page 11′, thereby indicating the correct answer of each question item. That is, the study reference book 1 of the invention comprises the question pages 6′, the explanation pages 9′, the rear-side question pages 11′, the rear-side explanation pages 15′, and a securing member 10 to secure the pages 6′, 9′, 11′ and 15′ into a book such that the question page 6′, the explanation page 9′, the rear-side question page 11′, and the rear-side explanation page 15′ are sequentially opened when leafing the pages. Although the securing member 10 is illustrated as a spring in FIGS. 2c and 2d, it should be noted that the member 10 is not limited to the spring, and that the member 10 may comprise various means such as a bonding agent for books, a binder for books, and the like.

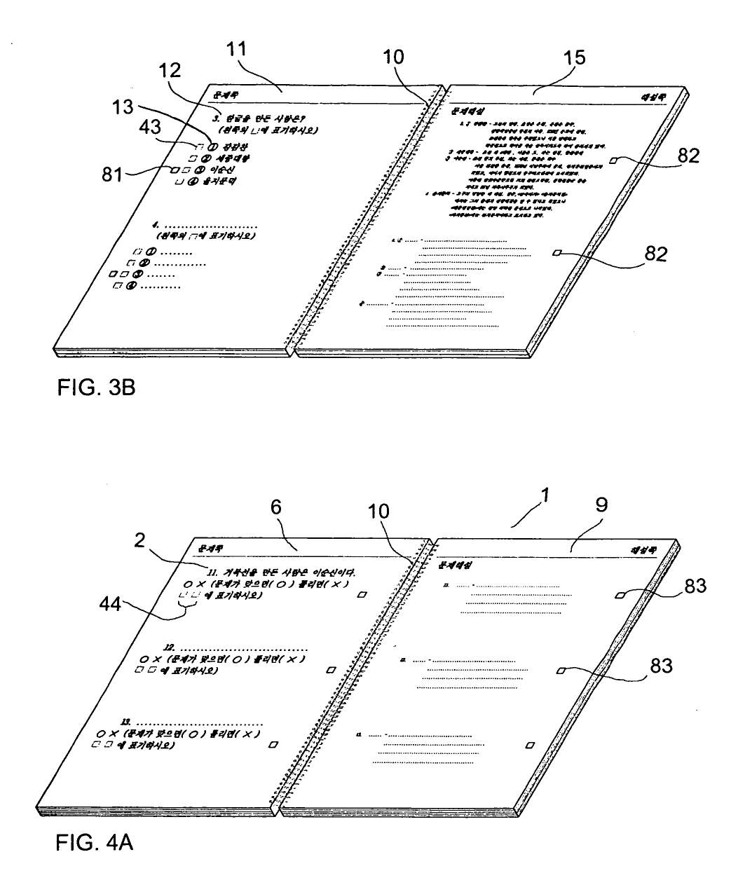

FIGS. 3a and 3b are views illustrating yet another embodiment of the study reference book according to the present invention.

In the embodiment shown in FIG. 3a, a question page 6 to evaluate learning content is positioned at a left page of the open study reference book 1, and comprises question items 2, multiple choice answers 3 of each question item 2 and an outer left side answer-marking part 42 positioned at a left side of the multiple choice answers 3. In addition, an explanation page 9 to help a user solve the question items is positioned at a right page thereon, and comprises an outer right end correct answer-punctured space 81 positioned to overlap an associated outer left side answer-marking part 42 on the question page 6 when leafing the explanation page 9 leftward to overlap the question page 6, thereby indicating the correct answer of each question item 2.

FIG. 3b shows the study reference book 1 when the explanation page 9 of FIG. 3a is leafed leftward. In the study reference book 1 shown in FIG. 2b, a rear-side question page 11 to continuously evaluate the learning content is positioned at the left page when the study reference book 1 is open by leafing the explanation page 9 having the outer right end correct answer-punctured space 81 leftward to overlap the question page 6. The rear-side question page 11 comprises question items 12, multiple choice answers 13 of each question item 2, and an inner left side answer-marking part 43 positioned at an inner left side of the multiple choice answers 13. In addition, a rear-side explanation page 15 to help the user solve the question items is positioned at the right page of the open study reference book. The rear-side explanation page 15 comprises an inner right end correct answer-punctured space 82 positioned to overlap an associated inner left side answer-marking part 43 on the rear-side question page 11 when leafing the explanation page 15 leftward to overlap the rear-side question page 11, thereby indicating the correct answer of each question item. That is, the study reference book 1 of the invention comprises the question pages 6, the explanation pages 9, the rear-side question pages 11, the rear-side explanation pages 15, and a securing member 10 to secure the pages 6, 9, 11 and 15 into a book such that the question page 6, the explanation page 9, the rear-side question page 11, and the rear-side explanation page 15 are sequentially opened when leafing the pages. Although the securing member 10 is illustrated as a spring in FIGS. 3a and 3b, it should be noted that the present invention is not limited to the spring, and that the securing member 10 may comprise various means such as a bonding agent for books, a binder for books, and the like.

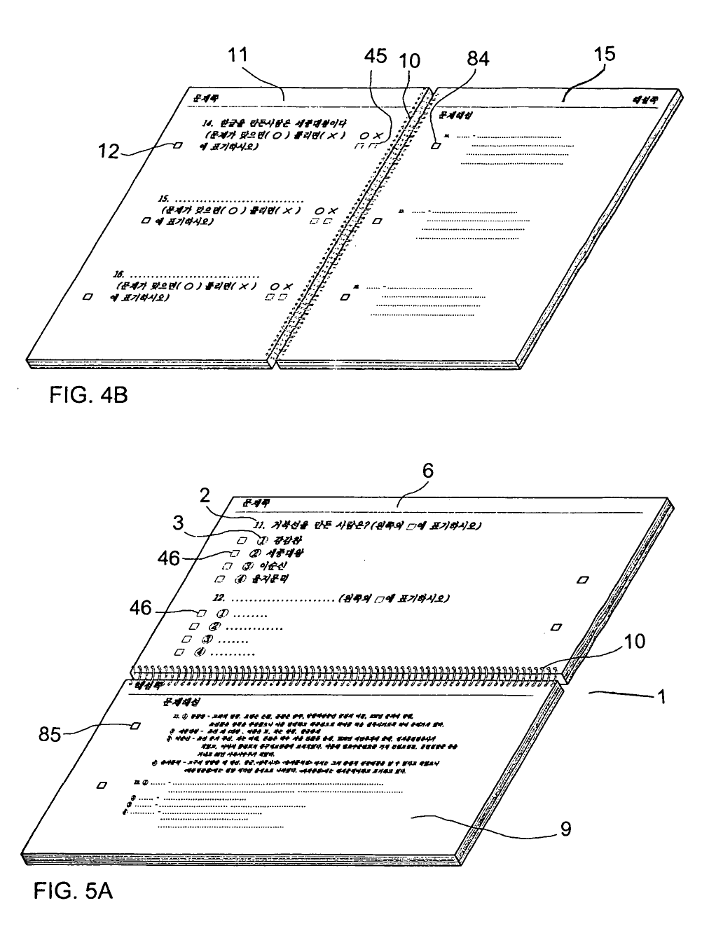

FIGS. 4a and 4b are views illustrating yet another embodiment of the study reference book according to the invention.

In the embodiment shown in FIG. 4a, a question page 6 to evaluate learning content is positioned at a left page of the open study reference book, and comprises a left side answer-marking part 4 positioned at a left side of each question item 2 such that the correct answer is marked by O or X in the left side answer-marking part 4. In addition, an explanation page 9 to help the user solve the question items is positioned at a right page, and comprises a right end correct answer-punctured space 83 positioned to overlap an associated left side answer-marking part 4 of the question page 6 when leafing the explanation page 9 leftward to overlap the question page 6, thereby indicating the correct answer of each question item 2.

FIG. 4b shows the study reference book 1 when the explanation page 9 of FIG. 4a is leafed leftward. In the study reference book 1 shown in FIG. 4b, a rear-side question page 11 to continuously evaluate the learning content is positioned at the left page when opening the study reference book 1 by leafing the explanation page 9 having the right end correct answer-punctured space 8 leftward to overlap the question page 6. The rear-side question page 11 comprises question items 12, and a left side answer-marking part 45 positioned at a left side of each question item 12. In addition, a rear-side explanation page 15 to help the user solve the question items is positioned at the right page of the open study reference book 1 in FIG. 4b. The rear-side explanation page 15 comprises a right end correct answer-punctured space 84 positioned to overlap an associated right side answer-marking part 45 on the rear-side question page 11 when leafing the explanation page 15 leftward to overlap the rear-side question page 11, thereby indicating the correct answer of each question item. That is, the study reference book 1 of the invention comprises the question pages 6, the explanation pages 9, the rear-side question pages 11, the rear-side explanation pages 15, and a securing member 10 to secure the pages 6, 9, 11 and 15 into a book such that the question page 6, the explanation page 9, the rear-side question page 11, and the rear-side explanation page 15 are sequentially opened when leafing the pages. Although the securing member 10 is illustrated as a spring in FIGS. 4a and 4b, it should be noted that the present invention is not limited to the spring, and that the securing member 10 may comprise various means such as a bonding agent for books, a binder for books, and the like.

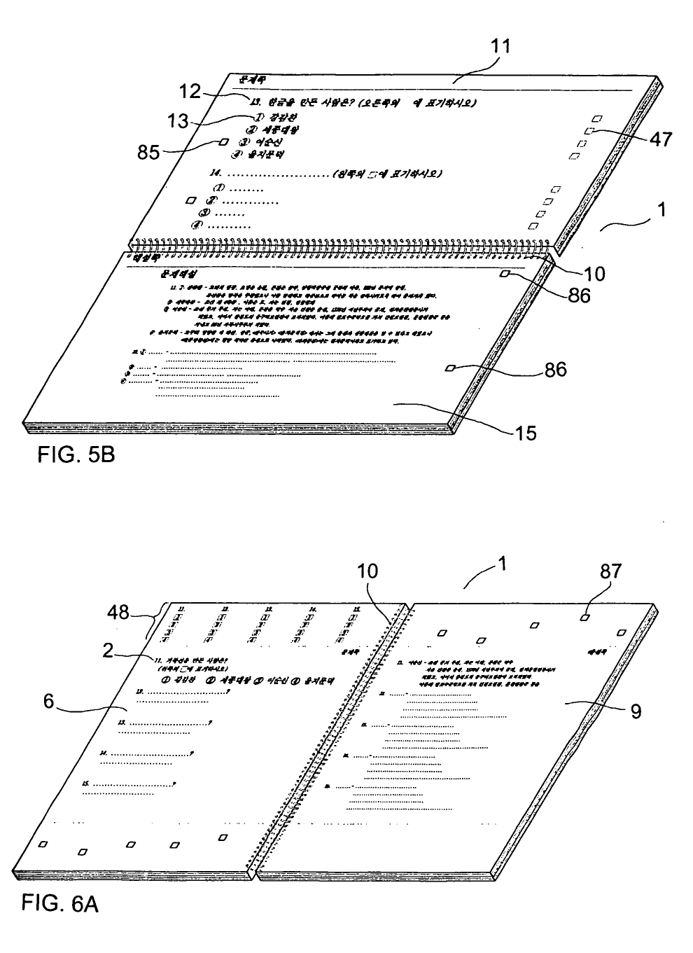

FIGS. 5a and 5b are views illustrating yet another embodiment of the study reference book according to the invention, in which the pages of the study reference book are leafed up and down around a spring securing member.

In the embodiment shown in FIG. 5a, a question page 6 to evaluate learning content is positioned at an upper page of the open study reference book 1, and comprises question items 2 set forth in parallel to a spring securing member of the reference book 1 and a left upper side answer-marking part 4 positioned at a left side of the multiple choice answers 3 of each question item 2. In addition, an explanation page 9 to help the user solve the question items is positioned at a lower page of the open study reference book 1, and comprises explanation items set forth in parallel to the spring securing member, and a left lower end correct answer-punctured space 85 positioned to overlap an associated left upper side answer-marking part 46 of the question page 6 when leafing the explanation page 9 upward to overlap the question page 6 at the upper side of the open study reference book, thereby indicating the correct answer of each question item 2.

FIG. 5b shows the study reference book 1 when the explanation page 9 of FIG. 5a is leafed upward. In the study reference book 1 shown in FIG. 5b, a rear-side question page 11 to continuously evaluate the learning content is positioned at the upper page of the study reference book 1 opened by leafing the explanation page 9 having the left lower end correct answer-punctured space 85 upward to overlap the question page 6. The rear-side question page 11 comprises question items 12, multiple choice answers 13 of each question item 2, and a right upper side answer-marking part 47 positioned at a right side of the multiple choice answers 13. In addition, a rear-side explanation page 15 to help the user solve the question items is positioned at the lower page. The rear-side explanation page 15 comprises a right lower end correct answer-punctured space 86 positioned to overlap an associated right side answer-marking part 47 on the rear-side question page 11 when leafing the explanation page 15 upward to overlap the rear-side question page 11, thereby indicating the correct answer of each question item. That is, the study reference book 1 of the invention comprises the question pages 6, the explanation pages 9, the rear-side question pages 11, the rear-side explanation pages 15, and the spring securing member 10 to secure the pages 6, 9, 11 and 15 into a book such that the question page 6, the explanation page 9, the rear-side question page 11, and the rear-side explanation page 15 are sequentially opened when leafing the pages. Although the securing member 10 is illustrated as a spring in FIGS. 5a and 5b, it should be noted that the present invention is not limited to the spring, and that the securing member 10 may comprise various means such as a bonding agent for books, a binder for books, and the like.

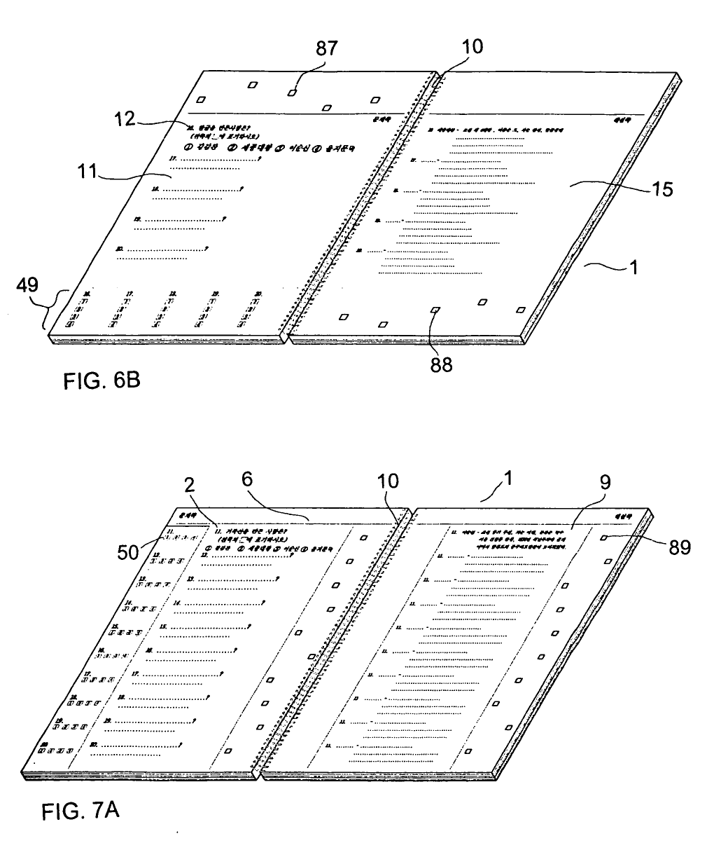

FIGS. 6a and 6b are views illustrating yet another embodiment of the study reference book according to the invention.

In the embodiment shown in FIG. 6a, a question page 6 to evaluate learning content is positioned at a left page of the open study reference book, and comprises question items 2, and an upper end answer-marking part 48 of each question item 2 positioned at an upper end of the question page 6 to allow a correct answer of the question item to be marked therein. In addition, an explanation page 9 to help a user solve the question items is positioned at a right page of the open study reference book, and comprises an upper end correct answer-punctured space 87 positioned to overlap an associated upper end answer-marking part 4 on the question page 6 when leafing the explanation page 9 leftward to overlap the question page 6, thereby indicating the correct answer of each question item 2.

FIG. 6b shows the study reference book 1 when the explanation page 9 of FIG. 6a is leafed leftward. In the study reference book 1 shown in FIG. 6b, a rear-side question page 11 to continuously evaluate the learning content is positioned at the left page when opening the study reference book 1 by leafing the explanation page 9 having the upper end correct answer-punctured space 87 leftward to overlap the question page 6. The rear-side question page 11 comprises question items 12, and a lower end answer-marking part 49 positioned at a lower end of the rear-side question page 11 below the question items 12. In addition, a rear-side explanation page 15 to help the user solve the question items is positioned at the right page. The rear-side explanation page 15 comprises a lower end correct answer-punctured space 88 positioned to overlap an associated lower end answer-marking part 49 on the rear-side question page 11 when leafing the explanation page 15 leftward to overlap the rear-side question page 11, thereby indicating the correct answer of each question item. That is, the study reference book 1 of the invention comprises the question pages 6, the explanation pages 9, the rear-side question pages 11, the rear-side explanation pages 15, and a securing member 10 to secure the pages 6, 9, 11 and 15 into a book such that the question page 6, the explanation page 9, the rear-side question page 11, and the rear-side explanation page 15 are sequentially opened when leafing the pages. Although the securing member 10 is illustrated as a spring in FIGS. 6a and 6b, it should be noted that the present invention is not limited to the spring, and that the securing member 10 may comprise various means such as a bonding agent for books, a binder for books, and the like.

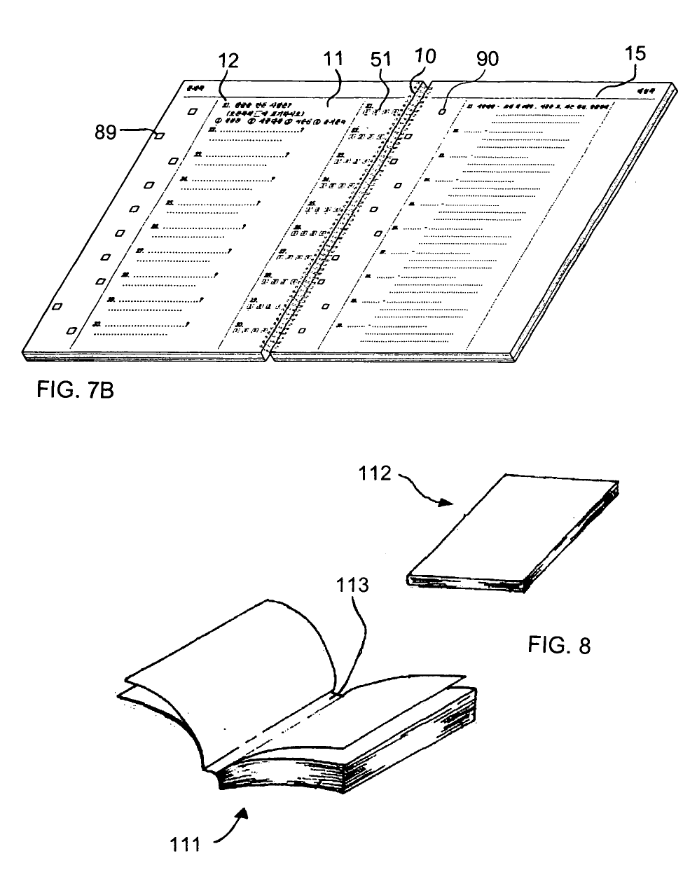

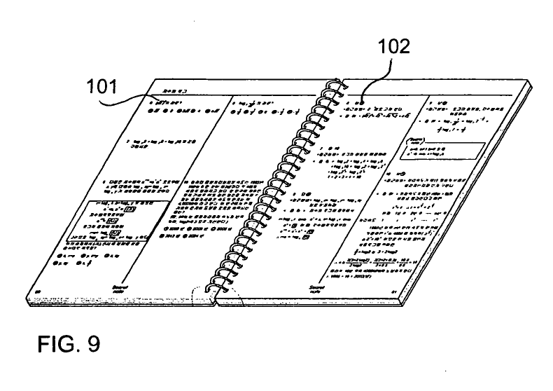

FIGS. 7a and 7b are views illustrating yet another embodiment of the study reference book according to the invention.

In the embodiment shown in FIG. 7a, a question page 6 to evaluate learning content is positioned at a left page of the open study reference book, and comprises question items 2, and a left side answer-marking part 50 positioned at a left side of an associated question item 2 allow a correct answer of the question item 2 to be marked therein. In addition, an explanation page 9 to help a user solve the question items is positioned at a right page of the open study reference book, and comprises a right side correct answer-punctured space 89 positioned to overlap an associated left side answer-marking part 4 of the question page 6 when leafing the explanation page 9 leftward to overlap the question page 6, thereby indicating the correct answer of the question item 2.

FIG. 7b shows the study reference book 1 when the explanation page 9 of FIG. 7a is leafed leftward. In the study reference book 1 shown in FIG. 7b, a rear-side question page 11 to continuously evaluate the learning content is positioned at the left page when opening the study reference book 1 by leafing the explanation page 9 having the right end correct answer-punctured space 89 leftward to overlap the question page 6. The rear-side question page 11 comprises question items 12, and a right side answer-marking part 51 positioned at a right side of each question item 12 on the rear-side question page 11. In addition, a rear-side explanation page 15 to help the user solve the question items is positioned at a right page. The rear-side explanation page 15 comprises a left end correct answer-punctured space 90 positioned to overlap an associated right side answer-marking part 41 of the rear-side question page 11 when leafing the explanation page 15 leftward to overlap the rear-side question page 11, thereby indicating the correct answer of each question item. That is, the study reference book 1 of the invention comprises the question pages 6, the explanation pages 9, the rear-side question pages 11, the rear-side explanation pages 15, and a spring securing member 10 to secure the pages 6, 9, 11 and 15 into a book such that the question page 6, the explanation page 9, the rear-side question page 11, and the rear-side explanation page 15 are sequentially opened when leafing the pages. Although the securing member 10 is illustrated as the spring in FIGS. 7a and 7b, it should be noted that the present invention is not limited to the spring, and that the securing member 10 may comprise various means such as a bonding agent for books, a binder for books, and the like.

As apparent from the above description, the study reference book of the invention provides an advantageous effect in that, when solving questions, the user can confirm whether or not an answer marked on a correct answer-marking part is a correct answer immediately after marking the answer.

The study reference book also provides an advantageous effect in that the user can confirm the correct answers without tearing out an answering appendix for confirmation of the correct answers after solving the questions.

The study reference book also provides an advantageous effect of reducing a time and effort for confirmation of the correct answers after solving the questions, thereby improving studying efficiency.

It should be understood that the embodiments and the accompanying drawings have been described for illustrative purposes and the present invention is limited by the following claims; Further, those skilled in the art will appreciate that various modifications, additions and substitutions are allowed without departing from the scope and spirit of the invention as set forth in the accompanying claims.

What is claimed is:

1. A study reference book, comprising:
question pages, each comprising question items to evaluate learning content, multiple choice answers related to each question item, an answer-marking part on which a correct answer of each question item is marked, and correct answer-punctured spaces for a previous question page to indicate a correct answer of each question item in the previous question page on the answer-marking part of the previous question page;
explanation pages, each being positioned at an opposing side of an associated question page when the study reference book is open, and comprising explanation items to enhance understanding of the question items, and a correct answer-punctured space positioned to locate correctly at a correct answer-indicating space of the answer-marking part in an associated question item of the question page when leafing the explanation page leftward to overlap the question page; and
a securing member to secure the pages such that the question page, and the explanation page are sequentially opened when leafing the pages.

2. The study reference book as set forth in claim 1, comprising:
the question pages to evaluate the learning content, each being positioned at a left page of the open study reference book, and comprising a left side answer-marking part positioned at a left side of the multiple choice answers of each question item;
the explanation pages to help a user solve the question items, each being positioned at a right page of the open study reference book, and comprising a right end correct answer-punctured space positioned to overlap an associated left side answer-marking part of the question page when leafing the explanation page leftward to overlap the question page, thereby indicating the correct answer of each question item;
rear-side question pages to continuously evaluate the learning content, each being positioned at the left page of the study reference book opened by leafing the explanation page having the right end correct answer-punctured space leftward to overlap the question page, and comprising a right side answer-marking part positioned at a right side of multiple choice answers of each question item;
rear-side explanation pages to help the user solve the question items, each being positioned at the right page of the open study reference book, and comprising a left end correct answer-punctured space positioned to overlap an associated right side answer-marking part of the rear-side question page when leafing the explanation page leftward to overlap the rear-side question page, thereby indicating the correct answer of each question item; and
a spring securing member to secure the pages into a book such that the question page, the explanation page, the rear-side question page, and the rear-side explanation page are sequentially opened when leafing the pages.

3. The study reference book as set forth in claim 1, wherein the engagement member is one of a spring, a bonding agent for books, and a binder for books.

4. The study reference book as set forth in claim 1, wherein the answer-marking part comprises marking spaces having a shape selected among a rectangular shape, circular shape, a triangular shape, a pentagonal shape, and a star shape.

5. The study reference book as set forth in claim 1, comprising:
the question pages to evaluate the learning content, each being positioned at a right page of the open study reference book, and comprising a left side answer-marking part positioned at a left side of the multiple choice answers of each question item;
the explanation pages to help the user solve the question items, each being positioned at a left page of the open study reference book, and comprising a right end correct answer-punctured space positioned to overlap an associated left side answer-marking part of the question page when leafing the explanation page rightward to overlap the question page, thereby indicating the correct answer of each question item;
rear-side question pages to continuously evaluate the learning content, each being positioned at the right page of the study reference book opened by leafing the explanation page having the right end correct answer-punctured space rightward to overlap the question page, and comprising a right side answer-marking part positioned at a right side of multiple choice answers of each question item;
rear side explanation pages to help the user solve the question items, each being positioned at the left page of the open study reference book, and comprising a left end correct answer-punctured space positioned to overlap an associated right side answer-marking part of the rear-side question page when leafing the explanation page rightward to overlap the rear-side question page, thereby indicating the correct answer of each question item; and
a spring securing member to secure the pages into a book such that the question page, the explanation page, the rear-side question page, and the rear-side explanation page are sequentially opened when leafing the pages.

6. The study reference book as set forth in claim 1, comprising;
the question pages to evaluate the learning content, each being positioned at a left page of the open study reference book, and comprising an outer left side answer-marking part positioned at a left side of the multiple choice answers of each question item;
the explanation pages to help a user solve the question items, each being positioned at a right page of the open study reference book, and comprising an outer right end correct answer-punctured space positioned to overlap an associated outer left side answer-marking part of the question page when leafing the explanation page leftward to overlap the question page, thereby indicating the correct answer of each question item;
rear-side question pages to continuously evaluate the learning content, each being positioned at the left page of the study reference book opened by leafing the explanation page having the outer right end correct answer-punctured space leftward to overlap the question page, and comprising an inner left side answer-marking part positioned at an inner left side multiple choice answers of each question item;
rear-side explanation pages to help the user solve the question items, each being positioned at the right page of the open study reference book, and comprising an inner right end correct answer-punctured space positioned to overlap an associated inner left side answer-marking part of the rear-side question page when leafing the explanation page leftward to overlap the rear-side question page, thereby indicating the correct answer of each question item; and
a spring securing member to secure the pages into a book such that the question page, the explanation page, the rear-side question page, and the rear-side explanation page are sequentially opened when leafing the pages.

7. The study reference book as set forth in claim 1, comprising:
the question pages to evaluate learning content, each being positioned at a left page of the open study reference book, and comprising a left side answer-marking part positioned at a left side of each question item such that the correct answer of each question item is marked by O or X in the left side answer-marking part;
the explanation pages to help the user solve the question items, each being positioned at a right page of the open study reference book, and comprising a right end correct answer-punctured space positioned to overlap an associated left side answer-marking part of the question page when leafing the explanation page leftward to overlap the question page, thereby indicating the correct answer of each question item;
rear-side question pages to continuously evaluate the learning content, each being positioned at the left page of the study reference book opened by leafing the explanation page having the right end correct answer-punctured space leftward to overlap the question page, and comprising a left side answer-marking part positioned at a left side of each question item;
rear-side explanation pages to help the user solve the question items, each being positioned at the right page of the open study reference book, and comprising a right end correct answer-punctured space positioned to overlap an associated left side answer-marking part of the rear-side question page when leafing the explanation page leftward to overlap the rear-side question page, thereby indicating the correct answer of each question item; and
a spring securing member to secure the pages into a book such that the question page, the explanation page, the rear-side question page, and the rear-side explanation page are sequentially opened when leafing the pages

8. The study reference book as set forth in claim 1, comprising:
the question pages to evaluate learning content, each being positioned at an upper page of the open study reference book, and comprising the question items set forth in parallel to a spring securing member of the reference book, and a left upper side answer-marking part positioned at a left side of the multiple choice answers of each question item;
the explanation pages to help the user solve the question items, each being positioned at a lower page of the open study reference book, and comprising the explanation items set forth in parallel to the spring securing member, and a left lower end correct answer-punctured space positioned to overlap an associated left upper side answer-marking part of the question page when leafing the explanation page upward to overlap the question page, thereby indicating the correct answer of each question item;
rear-side question pages to continuously evaluate the learning content, each being positioned at the upper page of the study reference book opened by leafing the explanation page having the left lower end correct answer-punctured space upward to overlap the question page, and comprising a right upper side answer-marking part positioned at a right side of the multiple choice answers of each question item;
rear-side explanation pages to help the user solve the question items, each being positioned at the lower page of the open study reference book, and comprising a right lower end correct answer-punctured space positioned to overlap an associated right side answer-marking part of the rear-side question page when leafing the explanation page upward to overlap the rear-side question page, thereby indicating the correct answer of each question item; and
the spring securing member to secure the pages into a book such that the question page, the explanation page, the rear-side question page, and the rear-side explanation page are sequentially opened when leafing the pages.

9. The study reference book as set forth in claim 1, comprising:
the question pages to evaluate the learning content, each being positioned at a left page of the open study reference book, and comprising an upper end answer-marking part of each question item positioned at an upper end of the question page to allow a correct answer of the question item to be marked therein;
the explanation pages to help a user solve the question items, each being positioned at a right page of the open study reference book, and comprising an upper end correct answer-punctured space positioned to overlap an associated upper end answer-marking part of the question page when leafing the explanation page leftward to overlap the question page, thereby indicating the correct answer of each question item;
rear-side question pages to continuously evaluate the learning content, each being positioned at the left page of the study reference book opened by leafing the explanation page having the upper end correct answer-punctured space leftward to overlap the question page, and comprising a lower end answer-marking part positioned at a lower end of the rear-side question page below question items of the rear-side question page;
rear-side explanation pages to help the user solve the question items, each being positioned at the right page of the open study reference book, and comprising a lower end correct answer-punctured space positioned to overlap an associated lower end answer-marking part of the rear-side question page when leafing the explanation page leftward to overlap the rear-side question page, thereby indicating the correct answer of each question item; and
a spring securing member to secure the pages into a book such that the question page, the explanation page, the rear-side question page, and the rear-side explanation page are sequentially opened when leafing the pages.

10. The study reference book as set forth in claim 1, comprising;
the question pages to evaluate learning content, each being positioned at a left page of the open study reference book, and comprising a left side answer-marking part positioned at a left side of an associated question item to allow a correct answer of the question item to be marked therein;
the explanation pages to help a user solve the question items, each being positioned at a right page of the open study reference book, and comprising a right side correct answer-punctured space positioned to overlap an associated left side answer-marking part of the question page when leafing the explanation page leftward to overlap the question page, thereby indicating the correct answer of the question item;
rear-side question pages to continuously evaluate the learning content, each being positioned at the left page of the study reference book opened by leafing the explanation page having the right end correct answer-punctured space leftward to overlap the question page, and comprising a right side answer-marking part positioned at a right side of each question item on the rear-side question page;
rear-side explanation pages to help the user solve the question items, each being positioned at the right page of the study reference book, and comprising a left end correct answer-punctured space positioned to overlap an associated right side answer-marking part of the rear-side question page when leafing the explanation page leftward to overlap the rear-side question page, thereby indicating the correct answer of each question item; and
a spring securing member to secure the pages into a book such that the question page, the explanation page, the rear-side question page, and the rear-side explanation page are sequentially opened when leafing the pages.
